(19) United States
(12) Patent Application Publication
(10) Pub. No.: US 2025/0148843 A1
(43) Pub. Date: May 8, 2025

(54) Systems and Methods for Automotive Diagnosis using Generative AI Models

(71) Applicant: Mick Zaatra, Temple Hills, MD (US)

(72) Inventor: Mick Zaatra, Temple Hills, MD (US)

(21) Appl. No.: 18/386,987

(22) Filed: Nov. 3, 2023

(51) Int. Cl. G07C 5/08; G06N 3/0455; G06N 3/08

(52) U.S. Cl. CPC G07C 5/0808; G06N 3/0455; G06N 3/08

(57) ABSTRACT

An artificial intelligence (AI) diagnostic display device for predicting automotive diagnosis. The AI diagnostic display being configured to: receive a set of symptomatic data of the vehicle relating to detected conditions of the vehicle, the symptomatic data including: (i) one or more symptoms comprising (A) one or more generated error codes from the vehicle and/or (B) one or more symptomatic descriptions of the vehicle from a user and (ii) date data of when each symptom was detected; receive a set of repair or maintenance procedures of the vehicle relating to addressing each symptom in the set of symptomatic data; input the set of symptomatic data and the set of repair or maintenance procedures into the generative diagnostic prediction machine learning model to generate one or more predicted error conditions of the vehicle; and/or present, via an interactive display, at least a portion of the one or more predicted error conditions.

### FIELD OF THE INVENTION

The present disclosure generally relates to systems and methods for generating automotive diagnosis and predicting automotive diagnosis using generative artificial intelligence models.

### BACKGROUND

As vehicles become more complex over time, accurately and efficiently diagnosing vehicle issues becomes increasingly difficult. Modern vehicles are equipped with a multitude of intricate electronics and sensors which can make identifying the root cause of malfunctions a challenge. In addition, modern vehicles also contain complex computing systems, meaning that technicians must also account for software-based malfunctions.

Another issue in diagnosing vehicle problems is interpreting error codes and driver symptom descriptions of the vehicle. Error codes generated by the vehicle can provide little to no indication as to what is wrong with a vehicle without additional context. Conversely, driver symptom descriptions can be unhelpful at best and direct the technician in the wrong direction at worst. As a result, technicians are often forced to conduct methodological troubleshooting to determine problems with a vehicle.

For the foregoing reasons, there is a need for systems and methods for generating automotive diagnosis and predicting automotive diagnosis using generative artificial intelligence models.

### SUMMARY

The disclosed systems and methods relate to the generation of automotive diagnosis/prognosis and and/or the prediction of automotive diagnosis/prognosis using generative artificial intelligence models.

In one example, an artificial intelligence (AI) diagnostic display device may be configured to predict automotive diagnosis comprises one or more processors, one or more memories accessible by the one or more processors, a generative diagnostic prediction machine learning model deployed on the one or more memories, an interactive display communicatively coupled to the one or more processors, and computing instructions stored on the one or more memories. The generative diagnostic prediction machine learning model may be trained on a training set of symptomatic data and a training set of repair or maintenance procedures, and the training set of symptomatic data may include: (i) one or more training symptoms comprising at least one of (A) one or more training generated error codes from a vehicle or (B) one or more training symptomatic descriptions of the vehicle and (ii) training date data of when each training symptom occurred. The computing instructions, when executed, may cause the one or more processors to: receive a set of symptomatic data of the vehicle relating to detected conditions of the vehicle, wherein each symptomatic data may include: (i) one or more symptoms comprising at least one of (A) one or more generated error codes from the vehicle or (B) one or more symptomatic descriptions of the vehicle from a user and (ii) date data of when each symptom was detected; receive a set of repair or maintenance procedures of the vehicle relating to addressing each symptom in the set of symptomatic data; input the set of symptomatic data and the set of repair or maintenance procedures into the generative diagnostic prediction machine learning model to generate one or more predicted error conditions of the vehicle; and/or present, via the interactive display, at least a portion of the one or more predicted error conditions.

In a further example, the generative diagnostic prediction machine learning model generates two or more predicted error conditions.

In a further example, generating the two or more predicted error conditions causes the one or more processors to generate a condition confidence score for each predicted error condition and/or sort the two or more predicted error conditions based upon a greatest value among the generated condition confidence scores.

In a further example, presenting the portion of the one or more predicted error conditions causes the one or more processors to present, via the interactive display, at least a portion of the sorted two or more predicted error conditions.

In a further example, wherein the computing instructions, when executed, further cause the one or more processors to: receive current symptomatic data related to a current condition of the vehicle; update the set of symptomatic data with the current symptomatic data; incorporate the updated set of symptomatic data into the training set of symptomatic data; and/or retrain the generative diagnostic prediction machine learning model using the updated training set of symptomatic.

In a further example, wherein the computing instructions, when executed, further cause the one or more processors to: generate one or more current repair or maintenance procedures of the vehicle to address one or more current symptoms of the current symptomatic data; present, via the interactive display, at least a portion of the one or more current repair or maintenance procedures; update the set of repair or maintenance procedures with the one or more current repair or maintenance procedures; incorporate the updated set of repair or maintenance procedures into the training set of repair or maintenance procedures; and/or retrain the generative diagnostic prediction machine learning model using the updated training set of repair or maintenance procedures.

In a further example, wherein two or more current repair or maintenance procedures are generated and/or generating the two or more current repair or maintenance procedures causes the one or more processors to: generate a confidence score for each current repair or maintenance procedure and/or sort the two or more current repair or maintenance procedures based upon a greatest value among the generated confidence scores.

In a further example, wherein presenting the portion of the one or more current repair or maintenance procedures causes the one or more processors to present, via the interactive display, at least a portion of the sorted two or more current repair or maintenance procedures.

In a further example, wherein the computing instructions, when executed, further cause the one or more processors to: receive a list of one or more missing items necessary to perform the one or more current repair or maintenance procedures; receive a geographical location of the user; determine one or more product listings of each missing item; sort the one or more product listings based one or more of: (i) price of each product listing or (ii) total distance between a geographical location of each product listing and the geographical location of the user; present, via the interactive display, at least a portion of the sorted one or more product listings; receive one or more user selections of the sorted one or more product listings; and/or order the missing items from the sorted one or more product listings based upon the one or more user selections.

In a further example, wherein the computing instructions, when executed, further cause the one or more processors to: present, via the interactive display, dynamic instructions on how to perform the one or more current repair or maintenance procedures, wherein the dynamic instructions change based upon one or more user interactions; receive, via the interactive display, one or more user interactions; update the dynamic instructions based upon the one or more interactions; and/or present, via the interactive display, the updated dynamic instructions.

In a further example, at least one of: (i) the portion of the one or more predicted error conditions, (ii) the portion of the one or more current repair or maintenance procedures, (iii) the portion of the sorted one or more product listings, (iv) the dynamic instructions, and/or (v) present are outputted by a chat-based dialogue having access to the generative diagnostic prediction machine learning model.

In a further example, the AI diagnostic display device receives at least one of: (i) the set of symptomatic data, (ii) the set of repair or maintenance procedures, (iii) the current symptomatic data, (iv) the list of one or more missing items, (v) the geographical location of the user, (vi) the one or more user selections, and/or (vii) the one or more user interactions via the user interacting with the chat-based dialogue using the interactive display.

In another example, an artificial intelligence (AI) based method for predictive automotive diagnosis is disclosed. The method may comprise: receiving, by one or more processors, a set of symptomatic data of a vehicle relating to detected conditions of the vehicle, wherein each symptomatic data may include: (i) one or more symptoms comprising at least one of (A) one or more generated error codes from the vehicle or (B) one or more symptomatic descriptions of the vehicle from a user and (ii) date data of when each symptom was detected; receiving, by the one or more processors, a set of repair or maintenance procedures of the vehicle relating to addressing each symptom in the set of symptomatic data; inputting, by the one or more processors, the set of symptomatic data and the set of repair or maintenance procedures into a generative diagnostic prediction machine learning model to generate one or more predicted error conditions of the vehicle, wherein the generative diagnostic prediction machine learning model is trained on a training set of symptomatic data and a training set of repair or maintenance procedures, and the training set of symptomatic data may include: (i) one or more training symptoms comprising at least one of (A) one or more training generated error codes from the vehicle or (B) one or more training symptomatic descriptions of the vehicle and (ii) training date data of when each training symptom occurred; and/or presenting, by the one or more processors onto an interactive display, at least a portion of the one or more predicted error conditions.

In a further example, the generative diagnostic prediction machine learning model generates two or more predicted error conditions.

In a further example, generating the two or more predicted error conditions causes generating, by the one or more processors, a condition confidence score for each predicted error condition and/or sorting, by the one or more processors, the two or more predicted error conditions based upon a greatest value among the generated condition confidence scores.

In a further example, presenting the portion of the one or more predicted error conditions causes presenting, by the one or more processors onto the interactive display, at least a portion of the sorted two or more predicted error conditions.

In a further example, wherein the method further comprises: receiving, by the one or more processors, current symptomatic data related to a current condition of the vehicle; updating, by the one or more processors, the set of symptomatic data with the current symptomatic data; incorporating, by the one or more processors, the updated set of symptomatic data into the training set of symptomatic data; and/or retraining, by the one or more processors, the generative diagnostic prediction machine learning model using the updated training set of symptomatic.

In a further example, wherein the method further comprises: generating, by the one or more processors, one or more current repair or maintenance procedures of the vehicle to address one or more current symptoms of the current symptomatic data; presenting, by the one or more processors onto the interactive display, at least a portion of the one or more current repair or maintenance procedures; updating, by the one or more processors, the set of repair or maintenance procedures with the one or more current repair or maintenance procedures; incorporating, by the one or more processors, the updated set of repair or maintenance procedures into the training set of repair or maintenance procedures; and/or retraining, by the one or more processors, the generative diagnostic prediction machine learning model using the updated training set of repair or maintenance procedures.

In a further example, wherein two or more current repair or maintenance procedures are generated and/or generating the two or more current repair or maintenance procedures causes: generating, by the one or more processors, a confidence score for each current repair or maintenance procedure and/or sorting, by the one or more processors, the two or more current repair or maintenance procedures based upon a greatest value among the generated confidence scores.

In a further example, wherein presenting the portion of the one or more current repair or maintenance procedures causes presenting, by the one or more processors onto the interactive display, at least a portion of the sorted two or more current repair or maintenance procedures.

In a further example, wherein the method further comprises: receiving, by the one or more processors, a list of one or more missing items necessary to perform the one or more current repair or maintenance procedures; receiving, by the one or more processors, a geographical location of the user; determining, by the one or more processors, one or more product listings of each missing item; sorting, by the one or more processors, the one or more product listings based one or more of: (i) price of each product listing or (ii) total distance between a geographical location of each product listing and the geographical location of the user; presenting, by the one or more processors onto the interactive display, at least a portion of the sorted one or more product listings; receiving, by the one or more processors, one or more user selections of the sorted one or more product listings; and/or ordering, by the one or more processors, the missing items from the sorted one or more product listings based upon the one or more user selections.

In a further example, wherein the method further comprises: presenting, by the one or more processors onto the interactive display, dynamic instructions on how to perform the one or more current repair or maintenance procedures, wherein the dynamic instructions change based upon one or more user interactions; receiving, via the interactive display, one or more user interactions; update the dynamic instructions based upon the one or more interactions; and/or presenting, via the interactive display, the updated dynamic instructions.

In a further example, at least one of: (i) the portion of the one or more predicted error conditions, (ii) the portion of the one or more current repair or maintenance procedures, (iii) the portion of the sorted one or more product listings, (iv) the dynamic instructions, and/or (v) present are outputted by a chat-based dialogue having access to the generative diagnostic prediction machine learning model.

In a further example, the one or more processors receives at least one of: (i) the set of symptomatic data, (ii) the set of repair or maintenance procedures, (iii) the current symptomatic data, (iv) the list of one or more missing items, (v) the geographical location of the user, (vi) the one or more user selections, and/or (vii) the one or more user interactions via the user interacting with the chat-based dialogue using the interactive display.

In another example, a tangible, non-transitory computer-readable medium storing instructions for tracking reusable containers is disclosed. The instructions, when executed by one or more processors, cause the one or more processors to: receive a set of symptomatic data of a vehicle relating to detected conditions of the vehicle, wherein each symptomatic data may include: (i) one or more symptoms comprising at least one of (A) one or more generated error codes from the vehicle or (B) one or more symptomatic descriptions of the vehicle from a user and (ii) date data of when each symptom was detected; receive a set of repair or maintenance procedures of the vehicle relating to addressing each symptom in the set of symptomatic data; input the set of symptomatic data and the set of repair or maintenance procedures into a generative diagnostic prediction machine learning model to generate one or more predicted error conditions of the vehicle, wherein the generative diagnostic prediction machine learning model is trained on a training set of symptomatic data and a training set of repair or maintenance procedures, and the training set of symptomatic data may include: (i) one or more training symptoms comprising at least one of (A) one or more training generated error codes from the vehicle or (B) one or more training symptomatic descriptions of the vehicle and (ii) training date data of when each predicted symptom occurred; and present, via an interactive display, at least a portion of the one or more predicted error conditions.

In a further example, the generative diagnostic prediction machine learning model generates two or more predicted error conditions.

In a further example, generating the two or more predicted error conditions causes generating, by the one or more processors, a condition confidence score for each predicted error condition and/or sorting, by the one or more processors, the two or more predicted error conditions based upon a greatest value among the generated condition confidence scores.

In a further example, presenting the portion of the one or more predicted error conditions causes presenting, by the one or more processors onto the interactive display, at least a portion of the sorted two or more predicted error conditions.

In a further example, wherein the stored instructions further comprise: receiving, by the one or more processors, current symptomatic data related to a current condition of the vehicle; updating, by the one or more processors, the set of symptomatic data with the current symptomatic data; incorporating, by the one or more processors, the updated set of symptomatic data into the training set of symptomatic data; and/or retraining, by the one or more processors, the generative diagnostic prediction machine learning model using the updated training set of symptomatic.

In a further example, wherein the stored instructions further comprise: generating, by the one or more processors, one or more current repair or maintenance procedures of the vehicle to address one or more current symptoms of the current symptomatic data; presenting, by the one or more processors onto the interactive display, at least a portion of the one or more current repair or maintenance procedures; updating, by the one or more processors, the set of repair or maintenance procedures with the one or more current repair or maintenance procedures; incorporating, by the one or more processors, the updated set of repair or maintenance procedures into the training set of repair or maintenance procedures; and/or retraining, by the one or more processors, the generative diagnostic prediction machine learning model using the updated training set of repair or maintenance procedures.

In a further example, wherein two or more current repair or maintenance procedures are generated and/or generating the two or more current repair or maintenance procedures causes: generating, by the one or more processors, a confidence score for each current repair or maintenance procedure and/or sorting, by the one or more processors, the two or more current repair or maintenance procedures based upon a greatest value among the generated confidence scores.

In a further example, wherein presenting the portion of the one or more current repair or maintenance procedures causes presenting, by the one or more processors onto the interactive display, at least a portion of the sorted two or more current repair or maintenance procedures.

In a further example, wherein the stored instructions further comprise: receiving, by the one or more processors, a list of one or more missing items necessary to perform the one or more current repair or maintenance procedures; receiving, by the one or more processors, a geographical location of the user; determining, by the one or more processors, one or more product listings of each missing item; sorting, by the one or more processors, the one or more product listings based one or more of: (i) price of each product listing or (ii) total distance between a geographical location of each product listing and the geographical location of the user; presenting, by the one or more processors onto the interactive display, at least a portion of the sorted one or more product listings; receiving, by the one or more processors, one or more user selections of the sorted one or more product listings; and/or ordering, by the one or more processors, the missing items from the sorted one or more product listings based upon the one or more user selections.

In a further example, wherein the stored instructions further comprise: presenting, by the one or more processors onto the interactive display, dynamic instructions on how to perform the one or more current repair or maintenance procedures, wherein the dynamic instructions change based upon one or more user interactions; receiving, via the interactive display, one or more user interactions; update the dynamic instructions based upon the one or more interactions; and/or presenting, via the interactive display, the updated dynamic instructions.

In a further example, at least one of: (i) the portion of the one or more predicted error conditions, (ii) the portion of the one or more current repair or maintenance procedures, (iii) the portion of the sorted one or more product listings, (iv) the dynamic instructions, and/or (v) present are outputted by a chat-based dialogue having access to the generative diagnostic prediction machine learning model.

In a further example, the one or more processors receives at least one of: (i) the set of symptomatic data, (ii) the set of repair or maintenance procedures, (iii) the current symptomatic data, (iv) the list of one or more missing items, (v) the geographical location of the user, (vi) the one or more user selections, and/or (vii) the one or more user interactions via the user interacting with the chat-based dialogue using the interactive display.

In accordance with the above, and with the disclosure herein, the present disclosure includes improvements in computer functionality and/or in improvements to other technologies. These improvements are due, at least in part, because the disclosures herein describe an increased intelligence and/or predictive ability in application servers and/or computing devices (e.g., host servers and/or client devices) using trained machine learning models (e.g., the generative diagnostic prediction machine learning model described herein). For example, the generative diagnostic prediction machine learning model, executing on an application server and/or computing device, is able to accurately predict when a vehicle will require repair and/or maintenance procedures, as well as which repairs and/or maintenance procedures will be required, based on historical data of the vehicle in addition to historical data of other similar vehicles.

In addition, the present disclosure describes improvements in the functioning of the computer itself at least because the computing systems and/or the computer devices described herein are made more efficient by the configuration, adjustment, and/or adaptation of a given machine-learning network architecture. For example, in some embodiments, fewer machine resources (e.g., processing cycles or memory storage) are used when the computing systems and/or the computer devices utilize machine-learning to analyze error codes and/or user symptomatic descriptions. Under conventional systems, technicians would be required to waste computer resources systematically troubleshooting a vehicle with specialized equipment. The implementations disclosed herein free up the computational resources of an underlying computing system, thereby making the computing systems and/or the computer devices described more efficient.

Additionally, the present disclosure describes improvements in the functioning any other technology or technical field because computing systems and/or computing devices are enhanced by leveraging the plurality of historical data to accurately predict, detect, and/or otherwise determine (i) a future error condition of the vehicle and/or (ii) a future repair and/or maintenance procedure of the vehicle. These enhancements improve upon conventional techniques at least because existing systems lack such predictive or classification functionality. In particular, conventional techniques can result in unnecessary diagnostic checks and/or repairs or maintenance because root cause of symptoms were not properly discovered.

Also, the underlying system is an improvement in the field of vehicle diagnosis and prognosis. The AI methods and systems described herein are designed to assist technicians in (i) accurately and efficiently identifying error conditions of the vehicle, (ii) determining the best repair and/or maintenance procedures for addressing any error conditions of the vehicle, (iii) and/or predict a future error condition and/or repair and/or maintenance procedure of the vehicle.

In addition, in some embodiments, the present disclosure describes the application of certain claim elements with, or by use of, a particular machine. For example, in some embodiments, the present disclosure details the use of artificial intelligence (AI) diagnostic display device that can connect to the diagnostic port of a vehicle and in some embodiments may utilize machine learning techniques without the connection of a server device.

Further, in some embodiments, the present disclosure describes specific features other than what is well-understood, routine, conventional activity in the field, and/or describes additional unconventional steps that confine the claims to a particular useful application. For example, the systems and methods for using natural language processing (NLP) to interpret driver symptomatic descriptions into meaningful data in conjunction with predictive modeling of past symptoms and error codes to accurately diagnose, prognose, and/or predict a future condition of the vehicle are steps that are both unconventional and non-routine in the field.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various embodiments of the system and methods disclosed therein. It should be understood that each Figure depicts a particular embodiment of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example computer system configured to predict automotive diagnosis, in accordance with various embodiments disclosed herein.

FIG. 2A illustrates exemplary machine learning servers, in accordance with various embodiments disclosed herein.

FIG. 2B illustrates an example machine learning training module, in accordance with various embodiments disclosed herein.

FIG. 3 illustrates an example method, in accordance with various embodiments disclosed herein.

FIG. 4A illustrates an example graphical user interface for the interactive acquiring and/or presentation of vehicle error codes, in accordance with various embodiments disclosed herein.

FIG. 4B illustrates an example graphical user interface for the interactive acquiring and/or presentation of vehicle symptomatic descriptions, in accordance with various embodiments disclosed herein.

FIG. 4C illustrates an example graphical user interface for the interactive presentation of dynamic instructions, in accordance with various embodiments disclosed herein.

FIG. 4D illustrates another example graphical user interface for the interactive presentation of dynamic instructions, in accordance with various embodiments disclosed herein.

FIG. 4E illustrates an example graphical user interface for the interactive presentation of a vehicle's repair or maintenance history and the prediction of future symptoms and/or repairs or procedures, in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION

### Exemplary Computer System

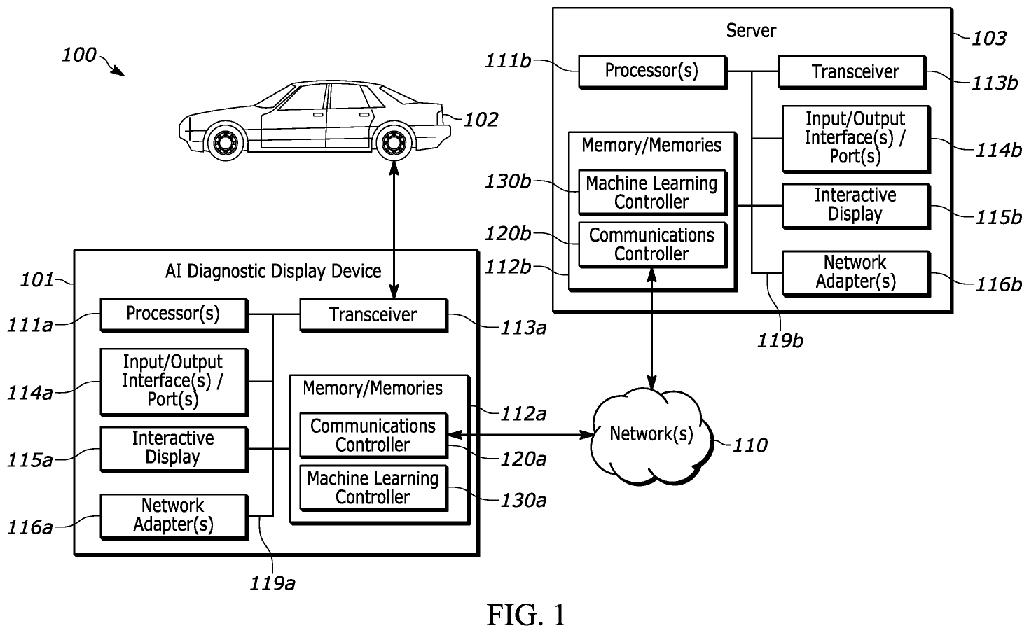

FIG. 1 depicts an exemplary computer system 100 for the implementation of the methods and systems described herein. The computer system 100 may include an artificial intelligence (AI) diagnostic display device 101, a vehicle 102, server(s) 103 and/or communication network(s) 110.

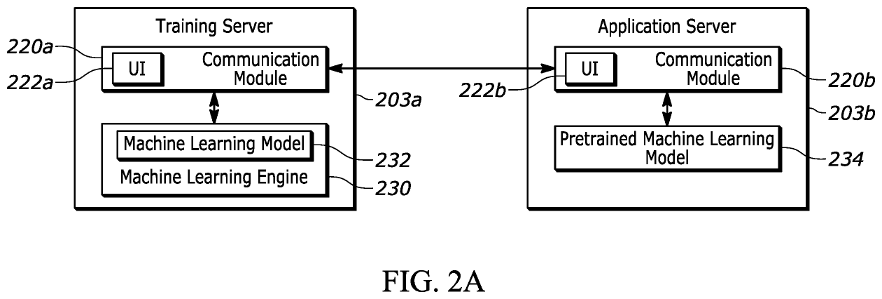

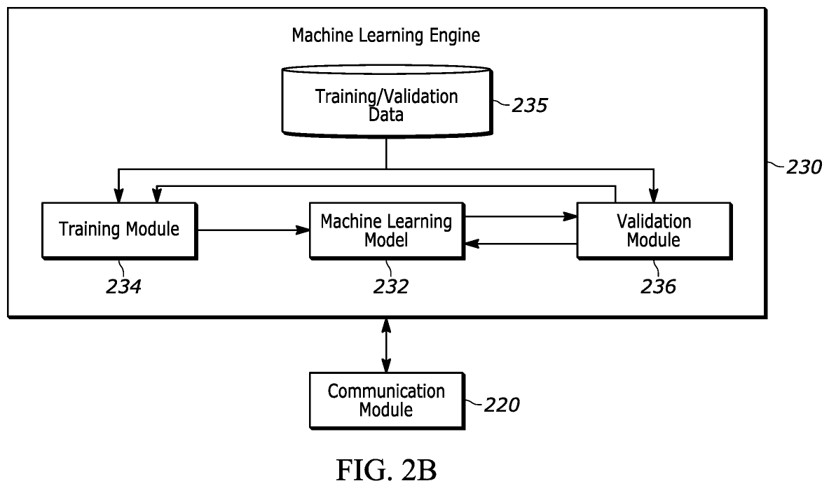

In some embodiments, the AI diagnostic display device 101 may include a computing assembly that has an interactive display (such as a laptop computer, a tablet, a mobile device, a smartphone or other smart device, a wearable device, smart contacts, smart glasses, headsets, etc.). The computing assembly may work in conjunction with a transceiver (e.g., capable of connecting to a vehicle diagnostic port). In some embodiments, the computing assembly may be configured to execute one or more machine learning models (e.g., the generative diagnostic prediction machine learning model). In particular, the AI diagnostic display device 101 may include one or more processors 111a, one or more computer memories 112a, a transceiver 113a, one or more input/output (I/O) ports 114a, an interactive display 115a, and/or one or more network adapters 116a. Any of these components may be communicatively coupled via a communications bus 119a. Additionally or alternatively, in some embodiments, the AI diagnostic display device 101 may execute the one or more machine learning model(s) (e.g., the pretrained machine learning model 234 as illustrated in FIG. 2A) without the need for a connection to the server(s) 103.

The vehicle 102 may be an internal combustion engine (ICE) vehicle, an electric vehicle (EV), a smart vehicle, etc. In some embodiments, the vehicle 102 may include a built-in computing system operatively coupled to one or more vehicle systems (e.g., a vehicle sensor system, a vehicle infotainment system, etc.). In these embodiments, the vehicle 102 may also include one or more transceivers and/or one or more network adapters for sending and receiving information over the communication network(s) 110. In some embodiments, the vehicle 102 may be communicatively coupled with the AI diagnostic display device 101 (e.g., via the transceiver 113a). In some embodiments, the vehicle may transmit data (e.g., error code data) to the AI diagnostic display device 101 (for example over a short-range wireless transmission such as Bluetooth®).

The server(s) 103, may comprise one or more computer servers. In various embodiments, the server(s) 103 may comprise multiple servers, which in turn may comprise multiple, redundant, and/or replicated servers as part of a server farm. In still further embodiments, the server(s) 103 may be implemented as cloud-based servers, such as a cloud-based computing platform. The server(s) 103 may include one or more processors 111b, one or more computer memories 112b, a transceiver 113b, one or more input/output (I/O) ports 114b, an interactive display 115b, and/or one or more network adapters 116b. Any of these components may be communicatively coupled via a communications bus 119b.

The one or more processors 111a of the AI diagnostic display device 101 and/or the one or more processors 111b of the server(s) 103 may include one or more central processing units (CPUs), one or more coprocessors, one or more microprocessors, one or more graphical processing units (GPUs), one or more digital signal processors (DSPs), one or more application specific integrated circuits (ASICs), one or more programmable logic devices (PLDs), one or more field-programmable gate arrays (FPGAs), one or more field-programmable logic devices (FPLDs), one or more microcontroller units (MCUs), one or more hardware accelerators, one or more special-purpose computer chips, and one or more system-on-a-chip (SoC) devices, etc.

The one or more memories 112a of the AI diagnostic display device 101 and/or the one or more memories 112b of the server(s) 103 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, solid state drives, flash memory, MicroSD cards, and others. The one or more memories 112a of the AI diagnostic display device 101 and/or the one or more memories 112b of the server(s) 103 may store an operating system (OS) (e.g., Microsoft Windows, Linux, UNIX, etc.) capable of facilitating the functionalities, apps, methods, or other software as discussed herein. In addition, the one or more memories 112a of the AI diagnostic display device 101 and/or the one or more memories 112b of the server(s) 103 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, and/or described for the various flowcharts, illustrations, diagrams, figures, and/or other disclosure herein. For example, the one or more memories 112a of the AI diagnostic display device 101 and/or the one or more memories 112b of the server(s) 103 may include and/or store application(s), software component(s), and/or APIs for the execution of one or more trained machine learning models. It should be appreciated that the stored machine readable instructions may executed by the one or more processors 111a of the AI diagnostic display device 101 and/or the one or more processors 111b of the server(s) 103. In some embodiments, the one or more memories 112b of the server(s) 103 may be or may include one or more databases, one or more data repositories, and/or the like.

The stored machine readable instructions of the AI diagnostic display device 101 may include a communications controller 120a and/or a machine learning controller 130a, and the stored machine readable instructions of the server(s) 103 may include a communications controller 120b and/or a machine learning controller 130b. The communications controller 120a and/or the communications controller 120b may configure the AI diagnostic display device 101 and/or the server(s) 103, respectively, to send and/or receive electronic data. The machine learning controller 130a and/or the machine learning controller 130b may configure the AI diagnostic display device 101 and/or the server(s) 103, respectively, to train, validate, and/or develop a machine learning model.

The transceiver 113a of the AI diagnostic display device 101 and/or the transceiver 113b of the server(s) 103 may be a dedicated electromagnetic transceiver device or a combination of electromagnetic receivers and electromagnetic transmitters. In some embodiments, the transceiver 113a of the AI diagnostic display device 101 and/or the transceiver 113b of the server(s) 103 may be any type of wireless transceiver (e.g., WI-FI transceivers, Bluetooth® transceivers, low energy radio transceivers, WWAN transceivers, WLAN transceivers, WPAN transceivers, etc.). The electric signals of the transceiver 113a of the AI diagnostic display device 101 and/or the transceiver 113b of the server(s) 103 described herein need not be radio frequencies (RF) nor be short range in application and/or implementation.

The one or more I/O ports 114a of the AI diagnostic display device 101 and/or the one or more I/O ports 114b of the server(s) 103 may include any number of different types of input units or output units, input circuits or output circuits, and/or input components or output components that enable the one or more processors 111a of the AI diagnostic display device 101 and/or the one or more processors 111b of the server(s) 103 to communicate with one or more input devices and/or one or more output devices. In some embodiments, the one or more I/O ports 114a of the AI diagnostic display device 101 and/or one or more I/O ports 114b of the server(s) 103 may be combined I/O units, I/O circuits, and/or I/O components. The one or more input devices may include keyboard(s) and/or keypad(s), interactive screen(s) (e.g., touch screens), navigation device(s) (e.g., a mouse, a trackball, a capacitive touch pad, a joystick, etc.), microphone(s), button(s), communication interface(s), etc. The one or more output devices may include display unit(s) (e.g., the interactive display 115a of the AI diagnostic display device 101, the interactive display 115b of the server(s) 103, etc.), speaker(s), etc.

The interactive display 115a of the AI diagnostic display device 101, the interactive display 115b of the server(s) 103 may include any display unit that allows for the input of a user either alone (e.g., a touch screen, a mixed or extended reality (MR) display, etc.) or in conjunction with one or more input devices (e.g., a monitor and a keyboard and/or mouse).

The one or more network adapters 116a of the AI diagnostic display device 101 and/or the one or more network adapters 116b of the server(s) 103 may include be one or more communication components configured to communicate (e.g., send and receive) data via one or more external/network port(s) to the communication network(s) 110. For example, the one or more network adapters 116a of the AI diagnostic display device 101 and/or the one or more network adapters 116b of the server(s) 103 may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over the communication network(s) 110. Additionally or alternatively, in various embodiments, one or more network adapters 116a of the AI diagnostic display device 101 and/or the one or more network adapters 116b of the server(s) 103 may include, or interact with, one or more transceivers (e.g., the transceiver 113a of the AI diagnostic display device 101 and/or the transceiver 113b of the server(s) 103) functioning in accordance with IEEE standards, 3GPP standards, or other standards, and that may be used in receipt and transmission of data via external/network ports connected to the communication network(s) 110.

The communications bus 119a of the AI diagnostic display device 101 and/or the communications bus 119b of the server(s) 103 may include any dedicated or general-purpose communication bus implementing a bus access protocol that facilitates the communications between the various components of the AI diagnostic display device 101 and/or the server(s) 103, respectively.

The communication network(s) 110 may comprise the internet, a local area network (LAN), a metropolitan area network (MAN), a wide area network (WAN), a wired network, a Wi-Fi network, a cellular network, a wireless network, a private network, a virtual private network, etc.

In some embodiments, the server(s) 103 may include a client-server platform technology such as ASP.NET, Java J2EE, Ruby on Rails, Node.js, and/or a web service or online API, responsive for receiving and responding to electronic requests. The server(s) 103 may implement the client-server platform technology that may interact, via the communication bus 119b, with the one or more memories 112b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

As described herein, in some embodiments, the server(s) 103 may perform the functionalities as discussed herein as part of a cloud network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, and/or the like) having such computer-readable program code or computer instructions embodied therein, wherein the computer-readable program code or computer instructions may be installed on or otherwise adapted to be executed by one or more processors 111a of the AI diagnostic display device 101 and/or the one or more processors 111b of the server(s) 103 (e.g., working in connection with the respective operating system in one or more memories 112a of the AI diagnostic display device 101 and/or the one or more memories 112b of the server(s) 103) to facilitate, implement, and/or perform the machine readable instructions, methods, processes, elements or limitations, as illustrated, depicted, and/or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

In operation, the application server 203b may establish a communicative connection with the AI diagnostic display device 101 and/or other server(s) 103 via the communication network(s) 110. In some embodiments, establishing the connection may include a user of the AI diagnostic display device 101, the other server(s) 103 and/or accessing an electronic profile stored with the application server 203b. In some embodiments, establishing the connection may include navigating to a webpage of a website and/or a digital application hosted by the application server 203b. In these embodiments, the AI diagnostic display device 101 and/or the other server(s) 103, as a client, may establish a client-host connection to the application server 203b, as a host. Additionally or alternatively, the AI diagnostic display device 101 and/or the other server(s) 103 may establish the client-host connection via an application run on the AI diagnostic display device 101 and/or the other server(s) 103. In some embodiments, the connection may be through either a third-party connection (e.g., an email server) or a direct peer-to-peer (P2P) connection/transmission.

The application server 203b may receive one or more sets of input data over the communication network(s) 110 via the communication module 220b. The communication module 220b may forward the one or more sets of input data to the pretrained machine learning model 234, which may output a result. The result may be returned to the communication module 220b which may in turn present the result to the user via the AI diagnostic display device 101 and/or the other server(s) 103.

The training server 203a may train, validate, and/or otherwise develop machine learning model(s) 232, e.g., based upon one or more sets of training data. In some embodiments, the resulting machine learning model(s) 232 may be classification models, such as a CNN, a logistic regression model, a naïve Bayes model, a support vector machine (SVM) model, and/or the like. Additionally or alternatively, in some embodiments, the training server 203a may develop machine learning model(s) 232, e.g., by finding meaningful relationships in unorganized data. Additionally or alternatively, in some embodiments, the training server 203a may develop machine learning model(s) 232, e.g., via a user-defined reward signal definition.

In some embodiments, once the training server 203a initially trains and/or initially develops the machine learning model(s) 232, the training server 203a may then validate the machine learning model(s) 232. In some embodiments, the training server 203a may segment out a set of validation data from the corpus of training data to use when validating model performance. In these embodiments, the training data is divided into a ratio of training data and validation data (e.g., 80% training data and 20% validation data). When the machine learning model(s) 232 are applied to the validation data, if the machine learning model(s) 232 satisfy validation metric(s) (e.g., accuracy, recall, area under curve (AUC), etc.) the machine learning model(s) 232 may be implemented as the pretrained machine learning model 234 to be used by the application server 203b. However, if the machine learning model(s) 232 do not satisfy validation metric(s), the training server 203a may continue training the machine learning model(s) 232 sing additional training data.

In some embodiments, the communication module 220b of the application server 203b interacts with the communication module 220a of the training server 203a to facilitate the development, training, validation, and/or deployment of the machine learning model(s) 232 (e.g., the communication module 220b of the application server 203b transmits training data to the communication module 220a of the training server 203a, the communication module 220a of the training server 203a transmits the resulting machine learning model(s) 232 to the communication module 220a of the application server 203b, etc.)

In some embodiments, the communication module 220b of the application server 203b may implement interactive user interface(s) (UIs) (e.g., a web-based interface, mobile application, command prompts, etc.) that may be presented by the AI diagnostic display device 101 and/or the other server(s) 103. In particular, the interactive UIs may be configured to enable the user to submit input data to application server 203b and/or receive results from the machine learning model(s) 232.

It should be appreciated that while specific elements, processes, devices, and/or components are described as part of the AI diagnostic display device 101 and/or the server(s) 103, other elements, processes, devices and/or components are contemplated.

### Machine Learning Embodiments

In various embodiments, the systems, methods, and/or techniques discussed herein may use machine learning (ML) (also known as artificial intelligence (AI)) techniques. For instance, a processor and/or a processing element (e.g., the one or more processors 111a of an AI diagnostic display device 101 and/or the one or more processors 111b of the server(s) 103) may be trained, validated, and/or otherwise developed using supervised machine learning, unsupervised machine learning, semi-supervised machine learning, and/or reinforcement learning. Further, the ML program may employ one or more artificial neural network, which may be convolutional neural network(s) (CNN), fully convolutional neural network(s) (FCN), deep learning neural network(s), and/or combined learning modules or programs that learn in two or more fields or areas of interest.

Machine learning may involve identifying and/or recognizing patterns in existing data in order to facilitate making predictions, estimates, and/or recommendations for subsequent data. ML models may be trained upon inputs (e.g., training data such as previous or historical symptomatic data previous or historical repair or maintenance procedures) in order to generate predictions (e.g., one or more predicted error conditions of the vehicle).

ML models may also be either static and/or dynamic. In a static model, the runtime/inference inputs remain unchanged and are the same as the training inputs used to train and/or validate the model. In a dynamic model, however, the runtime/inference inputs may change over time from the initial training data (also referred to as seed data).

In some embodiments, the ML programs may be trained and/or validated using labeled training data sets. The ML programs may utilize deep learning algorithms that may be primarily focused on pattern recognition and may be trained after processing multiple examples.

In supervised ML, a processing element identifies patterns in existing data to make predictions and/or classifications about subsequently received data. Specifically, the processing element is trained using training data, which includes example inputs, which may include features and associated labels. The training data is formatted so that the features explain or otherwise statistically correlate to the labels, such that an ML model outputs a prediction or classification corresponding to the label. Based upon the training data, the processing element may generate a predictive function which maps outputs to inputs and may utilize the predictive function to generate outputs based upon data inputs. In this way, the applied ML program, algorithm, and/or technique may determine and/or discover rules, relationships, and/or patterns between the exemplary inputs and the exemplary outputs. The exemplary inputs and exemplary outputs of the training data may include any of the data inputs or outputs described herein. In some embodiments, the processing element may be trained by providing it with a large sample of data with known characteristics or features. For example, as used herein, the features may be (i) historical symptomatic data that includes one or more symptoms (e.g., one or more generated error codes from a vehicle and/or one or more symptomatic descriptions of the vehicle) and/or date data of when each symptom occurred and/or (ii) previously performed repair or maintenance procedures. The labels, meanwhile, data may include conditions of the vehicle (e.g., diagnosed error conditions) and/or recommended repair or maintenance procedures (e.g., prognosed repairs to known or diagnosed conditions). In such embodiments, the historical symptomatic data and/or historical repair or maintenance procedures are used to train an ML model to predict one or more error conditions of the vehicle and/or predict one or more repair or maintenance procedures for the vehicle.

In unsupervised ML, the processing element finds meaningful relationships in unorganized data. Unlike supervised learning, unsupervised learning does not involve training based upon example inputs with associated outputs. Rather, in unsupervised learning, the processing element may organize unlabeled data according to a relationship determined by at least one ML method/algorithm employed by the processing element. Unorganized data may include any combination of data inputs and/or outputs as described herein. In an example, a ML model may be trained to search across and classify posts on forums for industry experts. These posts may feature one or more error codes and/or symptomatic descriptions as well as responses from experts interpreting the error codes and/or results from the poster as to the cause of the problem. In such embodiments, the system may pull data from these posts that may be used to train and/or validate one or more ML models.

In semi-supervised ML, the processing element may use thousands of individual supervised machine learning iterations to generate a structure across the multiple inputs and outputs. In this way, the processing element may be able to find meaningful relationships in the data, similar to unsupervised learning, while leveraging known characteristics or features in the data to make predictions.

In reinforcement ML, the processing element may optimize outputs based upon feedback from a reward signal. Specifically, the processing element may receive a user-defined reward signal definition, receive a data input, utilize a decision-making model to generate an output based upon the data input, receive a reward signal based upon the reward signal definition and the output, and alter the decision-making model so as to receive a stronger reward signal for subsequently generated outputs. In an example, a ML model may be trained to (i) interpret a user's input into executable instructions (e.g., user prompts directing the system to act in a natural language) and (ii) generate a response to the user's input (e.g., in a chat-based dialogue, or chatbot, that is responsive in a natural language). Reinforcement ML may work in conjunction with natural language processing (NLP) as well as other forms of machine learning.

Supervised ML, unsupervised ML, semi-supervised ML, and/or reinforcement ML may also comprise retraining, relearning, and/or otherwise updating models with new, or different, information, which may include information received, ingested, generated, or otherwise used over time. In some embodiments, one or more models may be trained and/or validated using any combination of the aforementioned training techniques. The disclosures herein may use any of the above-described machine learning techniques.

FIG. 2A depicts a diagram of exemplary machine learning servers (e.g., the server(s) 103 as illustrated in FIG. 1): a training server 203a and an application server 203b.

The training server 203a may include a communication module 220a and/or a machine learning engine 230. The communication module 220a may include UI 222a. The machine learning engine 230 may develop and/or store a machine learning model 232. The training server 203a may include a portion of a memory unit configured to store software and/or computer-executable instructions that, when executed by a processing unit, may train, validate, and/or otherwise develop the machine learning model 232 for predicting automotive diagnosis.

The application server 203b may include a communication module 220b and/or a pretrained machine learning model 234. The communication module 220b may include an interactive UI 222b via which, in some embodiments, one or more function calls are received. The application server 203b may include a portion of a memory unit configured to store software and/or computer-executable instructions that, when executed by a processing unit, may cause the one or more of the above-described components to predict automotive diagnosis. In some embodiments, application server 203b and the training server 203a may be the same server.

In some embodiments, the communication module 220b of the application server 203b may implement the interactive UI 222b (e.g., a web-based interface, mobile application server interface, etc.) that may populate an interactive display (e.g., the interactive display 115a of the AI diagnostic display device 101 and/or the interactive display 115b of the server(s) 103). In particular, the interactive UI 222b may be configured to enable the user to submit input data. In some embodiments, the communication module 220b may work in conjunction with or be configured to include a chat-based dialogue (e.g., an AI chatbot) to receive any input data from the user. For example, the interactive UI 222b may interface with the AI diagnostic display device 101 and/or the server(s) 103 to receive error codes from the vehicle and/or symptomatic descriptions from the user.

Additionally or alternatively, in some embodiments, the application server 203b, may assist the AI diagnostic display device 101 in predicting automotive diagnosis by using machine learning techniques. In these embodiments, the application server 203b may route one or more sets of input data received over the one or more networks 110 to the communication module 220b. The input data may include set of symptomatic data (e.g., one or more symptoms, such as one or more generated error codes from the vehicle and/or one or more symptomatic descriptions of the vehicle from a user, and/or date data of when each symptom was detected) and/or set of repair or maintenance procedures. The communication module 220b may forward the one or more sets of input data to the pretrained machine learning model 232, which may output a one or more predicted error conditions of the vehicle and/or one or more predicted repair or maintenance procedures. In these embodiments, the pretrained machine learning model 232 may be the machine learning model 232 trained, validated, and/or otherwise developed by the training server 203a. The resulting determination may be returned to the communication module 220b which may in turn provides the output of the machine learning model 232 to the AI diagnostic display device 101.

In these embodiments, the training server 203a may train, validate, and/or otherwise develop the machine learning model 232 based upon one or more sets of training image data. The machine learning model 232 may be a classification model, such as a CNN, a logistic regression model, a naïve Bayes model, a support vector machine (SVM) model, and/or the like.

Once the training server 203a initially trains and/or initially develops the machine learning model 232, the training server 203a may then validate the machine learning model 232. In some embodiments, the training server 203a segments out a set of validation data may be from the corpus of training data to use when validating model performance. In these embodiments, the training data is divided into a ratio of training data and validation data (e.g., 80% training data and 20% validation data). The machine learning model 232 may be trained using the training data until the machine learning model 232 satisfies a validation metric (e.g., accuracy, recall, area under curve (AUC), etc.) when applied to the validation data. After satisfying the validation metric, the training server 203a may provide model data of the machine learning model 232 such that the application server 203b is able to implement the model as the pretrained machine learning model 232.

It should be appreciated that while specific elements, processes, devices, and/or components are described as part of the application server 203b, other elements, processes, devices and/or components are contemplated.

FIG. 2B depicts a diagram of an exemplary machine learning training module. The machine learning training module may include a machine learning engine 230 and/or a communication module 220.

The machine learning engine 230 may include training and/or validation data 235, a training module 234 and/or a validation module 236. The machine learning engine 230 may include a portion of a memory unit (e.g., the one or more memories 112a of the AI diagnostic display device 101 and/or the one or more memories 112b of the server(s) 103) configured to store software and/or computer-executable instructions that, when executed by a processing unit (e.g., the one or more processors 111a of the AI diagnostic display device 101 and/or the one or more processors 111b of the server(s) 103), may cause the one or more of the above-described components to generate, develop, train, validate, and/or deploy one or more machine learning models 232 (e.g., to predict one or more error conditions of the vehicle and/or one or more repair or maintenance procedures). Once trained and validated, the one or more machine learning models 232 may be deployed or otherwise implemented to perform the methods, systems, or otherwise algorithms described herein.

The training and/or validation data 235 may include labelled data (e.g., one or more conditions of a vehicle, one or more repair or maintenance procedures performed, etc.) comprising one or more features (e.g., one or more symptoms of the vehicle, one or more past symptoms, and/or one or more past repair or maintenance procedures performed). The machine learning engine 230 may pass the training and/or validation data 235 to the training module 234 and/or the validation module 236. In some embodiments, the machine learning engine 230 segments out a portion of the training data to be a validation set. For example, the machine learning engine 230 may segment out 20%, 10%, 5%, etc., of the training data for the validation data set.

The training module 234 may utilize one or more machine learning programs, algorithms, and/or techniques to train the one or more machine learning models 232. In some embodiments, the one or more machine learning models 232 are a CNN, a FCN, or another type of neural network. Accordingly, the training process may include analyzing the labels applied to the training data to determine a plurality of weights associated with the various layers of the neural network.

The validation module 236 may validate the resulting one or more machine learning models 232 by determining a validation metric rate (e.g., accuracy, precision, recall, etc.) of the one or more machine learning models 232. If the validation metric of the one or more machine learning models 232 does not meet a predetermined threshold value, the validation module 236 may instruct the training module 234 to continue training the one or more machine learning models 232 until the one or more machine learning models 232 satisfies the validation metric.

Once the one or more machine learning models 232 satisfies the validation metric, the machine learning engine 230 may pass the resulting one or more machine learning models 232 to a communication module 220 which may then allow the one or more machine learning models 232 to be accessed by one or more remote servers.

The one or more machine learning models 232 may be developed, trained, and/or validated from multiple, parallel machine learning engines 230. It should be appreciated that while specific elements, processes, devices, and/or components are described as part of example machine learning training module, other elements, processes, devices and/or components are contemplated and/or the elements, processes, devices, and/or components may interact in different ways and/or in differing orders, etc. For example, in embodiments that utilize unsupervised machine learning, the machine learning engine 230 may have a pattern detection module (not shown)—instead of a training module 234 and a validation module 236—to implement one or more unsupervised machine learning programs, algorithms, and/or techniques (e.g., clustering methods such as k-means clustering) on the training data.

In some embodiments, the machine learning engine 230 may be utilized to train, validate, and/or otherwise deploy a generative diagnostic machine learning model for the generation of one or more error conditions of the vehicle. In these embodiments, the generative diagnostic machine learning model may be trained and/or validated on a training set of symptomatic data. The training set of symptomatic data may include one or more generated error codes from vehicles and/or one or more symptomatic descriptions of a vehicle (e.g., from a user). By analyzing the various symptoms of vehicles via known symptomatic data (features) and correlating these symptoms to diagnosed conditions (labels) the generative diagnostic machine learning model may be able to accurately diagnose a vehicle's condition based on symptomatic data (e.g. □error codes and/or symptomatic descriptions) as an input.

In some embodiments, the machine learning engine 230 may be utilized to train, validate, and/or otherwise deploy a generative prognostic machine learning model for the generation of one or more repair or maintenance procedures of a vehicle. In these embodiments, the generative prognostic machine learning model may be trained and/or validated on a training set of diagnostic conditions. The training set of diagnostic conditions may include one or more diagnosed error conditions and may include symptomatic data (e.g., generated error codes from vehicles and/or one or more symptomatic descriptions of a vehicle). By analyzing the various symptoms (e.g., symptomatic data) and/or diagnosed condition of vehicle (features) and correlating these symptoms and/or diagnosed conditions to prescribed repair or maintenance procedures (labels) the generative diagnostic machine learning model may be able to accurately prescribe a repair or maintenance procedure based on symptomatic data (e.g. □error codes and/or symptomatic descriptions) and/or a diagnosed condition of the vehicle as an input.

In some embodiments, the machine learning engine 230 may be utilized to train, validate, and/or otherwise deploy a generative diagnostic prediction machine learning model for the generation of one or more predicted error conditions of a vehicle and/or one or more predicted repair or maintenance procedures of a vehicle. In these embodiments, the generative diagnostic prediction machine learning model may be trained and/or validated a training set of symptomatic data and/or a training set of repair or maintenance procedures. The training set of symptomatic data may include (i) one or more training symptoms comprising at least one of (A) one or more training generated error codes from a vehicle or (B) one or more training symptomatic descriptions of the vehicle and (ii) training date data of when each training symptom occurred. The training set of repair or maintenance procedures may include the repair or maintenance procedures performed on the vehicles in the training set of symptomatic data. By analyzing the historical symptoms (e.g., symptomatic data), previously diagnosed conditions, and/or previously performed repair or maintenance procedures on vehicles (features) the generative diagnostic machine learning model may be able to utilize pattern recognition to accurately predict an error condition and/or a repair or maintenance procedure of a vehicle based on historical symptomatic data of the vehicle (e.g. □error codes and/or symptomatic descriptions), previously diagnosed conditions of the vehicle, and/or previously performed repair or maintenance procedures on the vehicle as an input.

### Exemplary Method

The devices and systems described herein may include one or more computers that may be configured to perform particular operations or actions by virtue of having software, firmware, hardware, or a combination of them installed on the system that in operation causes or cause the system to perform the actions, e.g., for predicting automotive diagnosis. For example, in various embodiments one or more computer programs (e.g., as described for FIGS. 1-2B herein) may be configured to perform particular operations or actions by virtue of including instructions that, when executed by data processing apparatus, cause the apparatus to perform the actions.

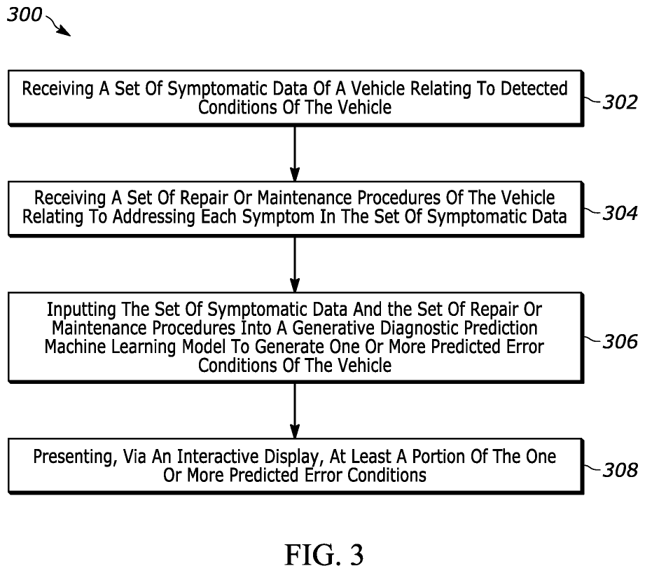

FIG. 3 depicts one embodiment, a method 300 that comprises, at block 302, receiving, by one or more processors, a set of symptomatic data of a vehicle relating to detected conditions of the vehicle, wherein each symptomatic data includes: (i) one or more symptoms comprising at least one of (A) one or more generated error codes from the vehicle or (B) one or more symptomatic descriptions of the vehicle from a user and (ii) date data of when each symptom was detected.

At block 304, method 300 further comprises receiving, by the one or more processors, a set of repair or maintenance procedures of the vehicle relating to addressing each symptom in the set of symptomatic data.

At block 306, method 300 further comprises inputting, by the one or more processors, the set of symptomatic data and the set of repair or maintenance procedures into a generative diagnostic prediction machine learning model to generate one or more predicted error conditions of the vehicle. In some embodiments, the generative diagnostic prediction machine learning model is trained on a training set of symptomatic data and a training set of repair or maintenance procedures, and the training set of symptomatic data includes: (i) one or more training symptoms comprising at least one of (A) one or more training generated error codes from the vehicle or (B) one or more training symptomatic descriptions of the vehicle and (ii) training date data of when each training symptom occurred.

At block 308, method 300 further comprises presenting, by the one or more processors onto an interactive display, at least a portion of the one or more predicted error conditions. Other embodiments include corresponding computer systems, apparatus, and computer programs recorded on one or more computer storage devices, each configured to perform the actions of the methods.

### Exemplary Graphical User Interfaces

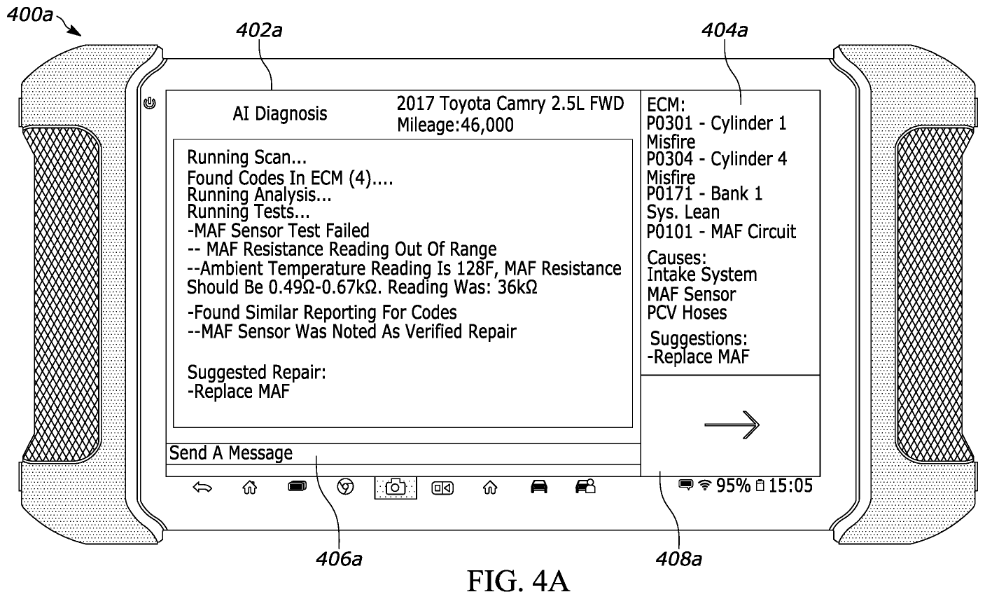

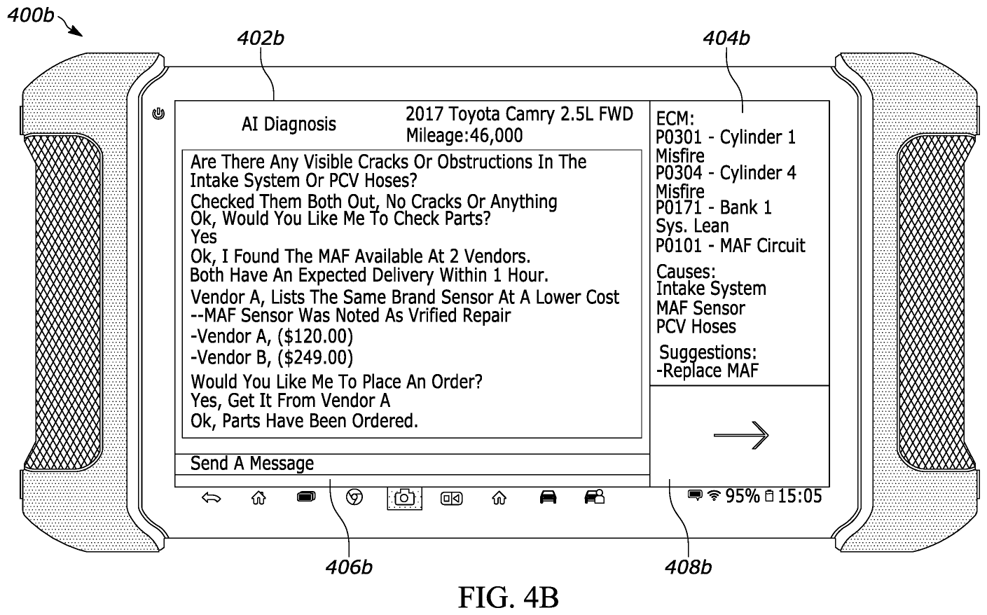

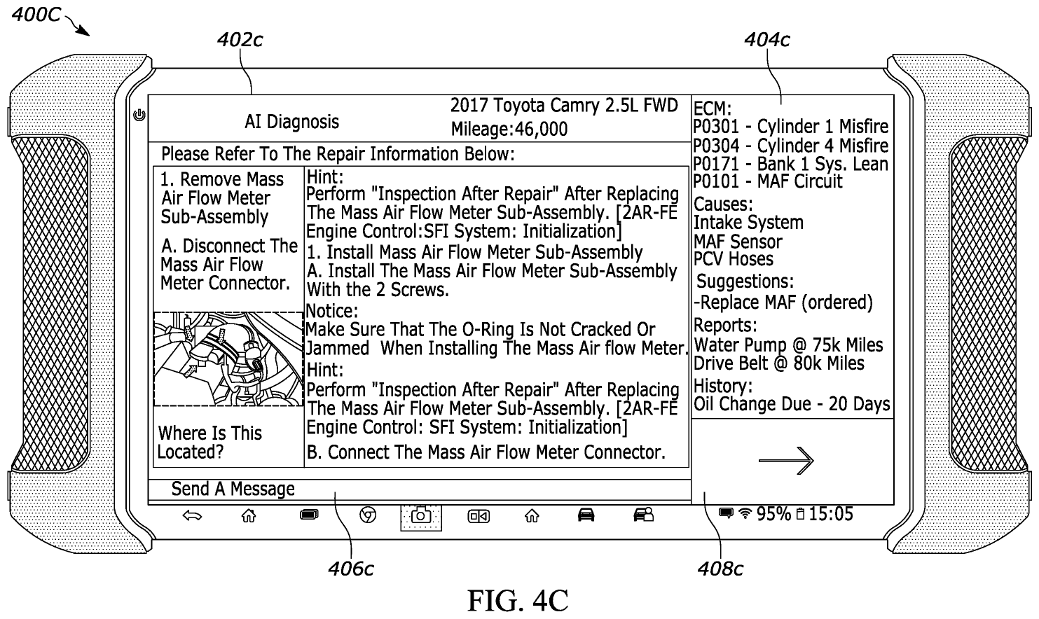

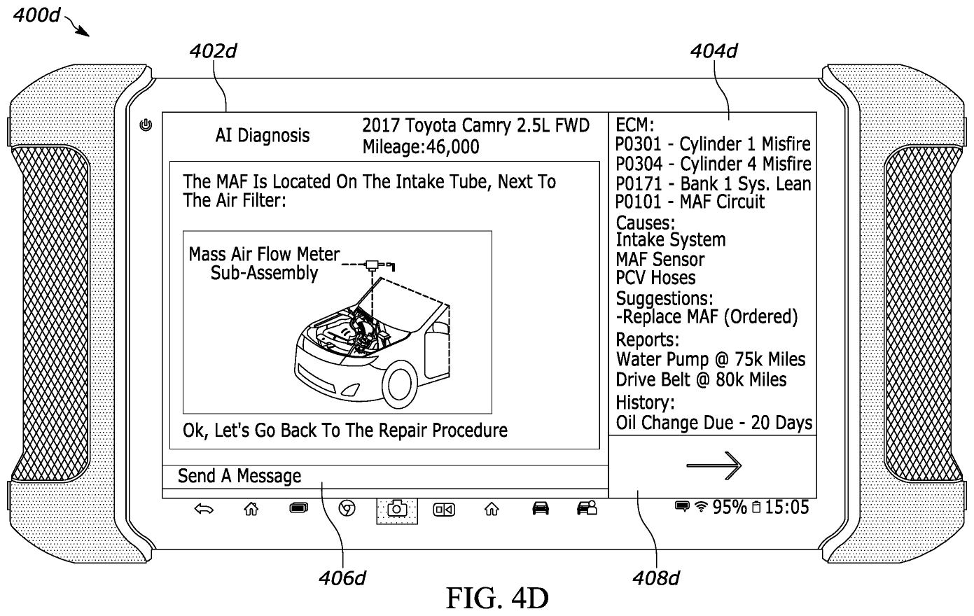

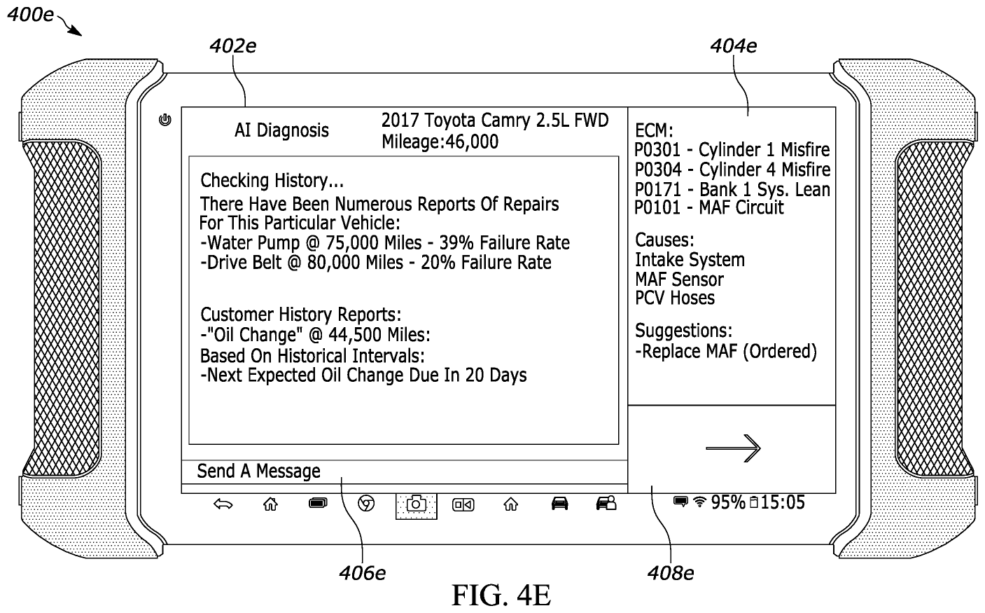

Details of operation of the methods and systems described herein are provided with respect to FIGS. 4A-4E, which depict example graphical user interfaces (GUIs) that may be displayed on an AI diagnostic display device (e.g., the AI diagnostic display device 101 as illustrated in FIG. 1). Particularly, FIG. 4A depicts an example GUI for the interactive acquiring and/or presentation of vehicle error codes, in accordance with various embodiments. FIG. 4B depicts an example GUI for the interactive acquiring and/or presentation of vehicle symptomatic descriptions, in accordance with various embodiments. FIGS. 4C-4D depict example GUIs for the interactive presentation of dynamic instructions, in accordance with various embodiments. FIG. 4E depicts an example GUI for the interactive presentation of a vehicle's repair or maintenance history and the prediction of future symptoms and/or repairs or procedures, in accordance with various embodiments disclosed. The GUIs of FIGS. 4A-4E may be displayed at the AI diagnostic display device based upon execution of non-transitory computer-executable instructions included in one or more digital application (as described herein) stored at the AI diagnostic display device.

FIG. 4A depicts an example error code GUI 400a via which the AI diagnostic display device may receive one or more error codes from a vehicle (e.g., the vehicle 102 as illustrated in FIG. 1). In one embodiment, as illustrated by FIG. 4A, the error code GUI 400a may include a non-interactable status 402a (e.g., the text of “Running Scan . . . ,” “Found Codes in ECM (4) . . . ,” “Running Analysis . . . ,” etc.), a non-interactable summary 404a (e.g., the text of “P0301—Cylinder 1 Misfire,” “P0304—Cylinder 4 Misfire,” “P0171—Ank 1 Sys. Lean,” and “P0101—MAF Circuit” under “ECM:;” “Intake System,” “MAF Sensor,” and “PCV Hoses” under “Causes:;” and “Replace MAF” under “Suggestions:”), an interactable input element 406a (e.g., the input text box element featuring the text “Send a message”), and/or an interactable element 408a (e.g., the interactable button that features a right-facing arrow). As illustrated in FIG. 4A, the error code GUI 400a, may also feature additional GUI elements at the bottom of the GUI that may or may not be interactable (e.g., a home button GUI element that brings the user to a home GUI upon interacting with it, a non-interactable battery GUI element, etc.).

The user interacting with the interactable input element 406a may input text and/or numeric values. For example, the user interacting with the input text box element featuring the text “Send a message” may cause an interactive keyboard GUI (not shown) to be displayed allowing the user to enter text and/or numeric values into the interactable input element 406a (e.g., the text “Yes” and/or the text “Yes, get it from Vendor A”, as illustrated in FIG. 4B). As another example, the user interacting with one or more external devices (e.g., a mouse and keyboard) may be able to enter text and/or numeric values into the interactable input element 406a. The user interacting with the interactable element 408a may cause the input data (e.g., text and/or numeric values) in the interactable input element 406a to be transmitted to the one or more computing systems described herein (e.g., the generative diagnostic machine learning model, the generative prognostic machine learning model, and/or the generative diagnostic prediction machine learning model). For example, the user interacting with the interactable button that features a right-facing arrow may cause the text “Yes” or “Yes, get it from Vendor A” to be transmitted to the one or more computing systems, as illustrated in FIG. 4B.

FIG. 4B depicts an example symptomatic intake GUI 400b via which the AI diagnostic display device may receive one or more symptomatic descriptions from a user. In one embodiment, as illustrated by FIG. 4B, the symptomatic intake GUI 400b may include a non-interactable status 402b (e.g., the text of “Are there any visible Cracks of Obstructions in the Intake System or PCV Hoses,” “Ok, Would you like me to check parts?,” “Okay, I found the MAF available at 2 vendors. Both have an expected delivery within 1 hour. Vendor A, lists the same brand sensor at a lower cost,” etc.), a non-interactable summary 404b (e.g., the text of “P0301—Cylinder 1 Misfire,” “P0304—Cylinder 4 Misfire,” “P0171—Ank 1 Sys. Lean,” and “P0101—MAF Circuit” under “ECM:;” “Intake System,” “MAF Sensor,” and “PCV Hoses” under “Causes:;” and “Replace MAF” under “Suggestions:”), an interactable input element 406b (e.g., the input text box element featuring the text “Send a message”), and/or an interactable element 408b (e.g., the interactable button that features a right-facing arrow). As illustrated in FIG. 4B, the symptomatic intake GUI 400b, may also feature additional GUI elements at the bottom of the GUI that may or may not be interactable (e.g., a home button GUI element that brings the user to a home GUI upon interacting with it, a non-interactable battery GUI element, etc.).

The user interacting with the interactable input element 406b may input text and/or numeric values. For example, the user interacting with the input text box element featuring the text “Send a message” may cause an interactive keyboard GUI (not shown) to be displayed allowing the user to enter text and/or numeric values into the interactable input element 406b (e.g., the text “Checked them both out, no cracks or anything,” the text “Yes,” and/or the text “Yes, get it from Vendor A”). As another example, the user interacting with one or more external devices (e.g., a mouse and keyboard) may be able to enter text and/or numeric values into the interactable input element 406b. The user interacting with the interactable element 408b may cause the input data (e.g., text and/or numeric values) in the interactable input element 406b to be transmitted to the one or more computing systems described herein (e.g., the generative diagnostic machine learning model, the generative prognostic machine learning model, and/or the generative diagnostic prediction machine learning model). For example, the user interacting with the interactable button that features a right-facing arrow may cause the text “Checked them both out, no cracks or anything,” the text “Yes,” and/or the text “Yes, get it from Vendor A” to be transmitted to the one or more computing systems.

In operation, the AI diagnostic display device may receive one or more error codes from the vehicle (e.g., via the transceiver 113a) as shown in FIG. 4A (e.g., error codes P0301, P0304, P0171, and P0101) and/or one or more symptomatic descriptions of the vehicle from the user (e.g., via the user interacting with the interactable input element 406b of the symptomatic intake GUI 400b) as shown in FIG. 4B. The one or more error codes and/or the one or more symptomatic descriptions may then be input into the generative diagnostic machine learning model to determine a current condition of the vehicle and/or the generative prognostic machine learning model to determine a suggestive repair or maintenance procedure to be performed on the vehicle. As illustrated in FIGS. 4A and 4B, the AI diagnostic display device may then output a result of the generative diagnostic machine learning model (e.g., the current condition of the vehicle) and/or the generative prognostic machine learning model (e.g., the suggested repair or maintenance procedure to be performed on the vehicle) to the user. In these illustrated examples, the computing system has determined that the mass air flow (MAF) sensor of the vehicle is not functional (e.g., the current condition of the vehicle) and the MAF sensor should be replaced (e.g., the suggested repair or maintenance procedure to be performed on the vehicle).

In some embodiments, the computing system may also utilize one or more reinforcement machine learning models via a chat-based dialogue (e.g., a chatbot) to deconstruct and interpret the user's inputs via the interactable input element 406a and/or the interactable input element 406b and generate response to those inputs. Additionally or alternatively, the computing system may also perform one or more part search functions based upon any repair or maintenance procedure outputs. For example, as illustrated in FIG. 4B, upon suggesting that the MAF sensor of the vehicle should be replaced, the computing system can search for MAF sensors compatible with the vehicle across vehicle parts stores within a defined radius (e.g., 10 miles) relative to the geographic location of the vehicle. Additionally, the computer system may also order any parts searched in this way on the user's behalf, as illustrated in FIG. 4B.

FIGS. 4C-4D depict example dynamic instruction GUIs 400c and 400d, respectively, via which the AI diagnostic display device may display one or more dynamic instructions to a user. In one embodiment, as illustrated by FIG. 4C, the dynamic instruction GUI 400c may include instructions 402c (e.g., the text of “Please refer to the repair information below:,” “1., REMOVE MASS AIR FLOW METER SUB-ASSEMBLY,” etc., the image of a mass air flow meter and its location in a vehicle, the indicators of one or more arrows, etc.) that may be either non-interactable or interactable (e.g., a user interacting with an image causes an enlarged version of the image to be displayed), a non-interactable summary 404c (e.g., the text of “P0301—Cylinder 1 Misfire,” “P0304—Cylinder 4 Misfire,” “P017—Ank 1 Sys. Lean,” and “P0101—MAF Circuit” under “ECM:;” “Intake System,” “MAF Sensor,” and “PCV Hoses” under “Causes:;” “Replace MAF” under “Suggestions:;” the text of “Water Pump @ 75K Miles” and “Drive Belt @ 80K Miles” under “Reports:;” and “Oil Change Due—20 days” under “History:”), an interactable input element 406c (e.g., the input text box element featuring the text “Send a message”), and/or an interactable element 408c (e.g., the interactable button that features a right-facing arrow). As illustrated in FIG. 4C, the dynamic instruction GUI 400c, may also feature additional GUI elements at the bottom of the GUI that may or may not be interactable (e.g., a home button GUI element that brings the user to a home GUI upon interacting with it, a non-interactable battery GUI element, etc.).

In another embodiment, as illustrated by FIG. 4D, the dynamic instruction GUI 400d may include instructions 402d (e.g., the text of “The MAF is located on the Intake Tube, next to the Air Filter,” etc., the image of an engine block of a vehicle, the contextual lines indicating the position of the MAF in the engine block, etc.) that may be either non-interactable or interactable (e.g., a user interacting with an image causes an enlarged version of the image to be displayed), a non-interactable summary 404d (e.g., the text of “P0301—Cylinder 1 Misfire,” “P0304—Cylinder 4 Misfire,” “P017—Ank 1 Sys. Lean,” and “P0101—MAF Circuit” under “ECM:;” “Intake System,” “MAF Sensor,” and “PCV Hoses” under “Causes:;” “Replace MAF” under “Suggestions:;” the text of “Water Pump @ 75K Miles” and “Drive Belt @ 80K Miles” under “Reports:;” and “Oil Change Due—20 days” under “History:”), an interactable input element 406d (e.g., the input text box element featuring the text “Send a message”), and/or an interactable element 408d (e.g., the interactable button that features a right-facing arrow). As illustrated in FIG. 4D, the dynamic instruction GUI 400d, may also feature additional GUI elements at the bottom of the GUI that may or may not be interactable (e.g., a home button GUI element that brings the user to a home GUI upon interacting with it, a non-interactable battery GUI element, etc.).

The user interacting with the interactable input element 406c and/or the interactable input element 406d may input text and/or numeric values. As an example, the user interacting with the input text box element featuring the text “Send a message” may cause an interactive keyboard GUI (not shown) to be displayed allowing the user to enter text and/or numeric values into the interactable input element 406c and/or the interactable input element 406d (e.g., the text “Where is this located?” as illustrated in FIG. 4C, the text “Ok, let's go back to the repair procedure” as illustrated in FIG. 4D, etc.). As another example, the user interacting with one or more external devices (e.g., a mouse and keyboard) may be able to enter text and/or numeric values into the interactable input element 406c and/or the interactable input element 406d. The user interacting with the interactable element 408c and/or the interactable element 408d may cause the input data (e.g., text and/or numeric values) in the interactable input element 406c and/or the interactable input element 406d to be transmitted to the one or more computing systems described herein (e.g., the generative diagnostic machine learning model, the generative prognostic machine learning model, and/or the generative diagnostic prediction machine learning model). For example, the user interacting with the interactable button that features a right-facing arrow may cause the text “Where is this located?” to be transmitted to the one or more computing systems, as illustrated in Figure C. As another example, the user interacting with the interactable button that features a right-facing arrow may cause the text “Ok, let's go back to the repair procedure” to be transmitted to the one or more computing systems, as illustrated in Figure D.

In operation, the AI diagnostic display device initially may display the instructions 402c as illustrated in FIG. 4C. The AI diagnostic display device may then receive one or more text-based directions from the user (e.g., via the user interacting with the interactable input element 406c of the dynamic instruction GUI 400c). The computing system may utilize one or more reinforcement machine learning models via a chat-based dialogue (e.g., a chatbot) to deconstruct and interpret the user's inputs via the interactable input element 406c generate response to those inputs. In particular, the computing system may alter the displayed instructions 402 and/or display alternate instructions (e.g., via the dynamic instruction GUI 400d). In the illustrated scenario, the user enters the text “Where is this located?” and the computing system determines that the user needs additional instructions as to the location of the MAF sensor that the user is attempting to replace. As such, in response to receiving and interpreting the user's input, the AI diagnostic display device initially then display the instructions 402d as illustrated in FIG. 4D. Also illustrated in the figures, the above steps may be repeated to cause additional or previous instructions to be displayed on the AI diagnostic display device (e.g., the user enters “Ok, let's go back to the repair procedure” to cause the instructions 402c to be displayed on the AI diagnostic display device).

FIG. 4E depicts an example output GUI 400e via which the AI diagnostic display device may display one or more outputs from the one or more machine learning models described herein a user. In one embodiment, as illustrated by FIG. 4E, the output GUI 400e may include a non-interactable status and outputs 402e (e.g., the text-based statuses of “Checking History . . . ,” “Customer History reports:,” and “Based on historical intervals,” and the text-based outputs of “There have been numerous reports of repairs for this particular Vehicle: —Water Pump @ 75,000 Miles—39% failure rate—Drive Belt @ 80,000 Miles—20% failure rate,” “—‘Oil Change’ @ 44,500 Miles,” and “—Next expected Oil Change Due in 20 days”), a non-interactable summary 404e (e.g., the text of “P0301—Cylinder 1 Misfire,” “P0304—Cylinder 4 Misfire,” “P017—Ank 1 Sys. Lean,” and “P0101—MAF Circuit” under “ECM:;” “Intake System,” “MAF Sensor,” and “PCV Hoses” under “Causes:;” and “Replace MAF” under “Suggestions:”), an interactable input element 406e (e.g., the input text box element featuring the text “Send a message”), and/or an interactable element 408e (e.g., the interactable button that features a right-facing arrow). As illustrated in FIG. 4E, the output GUI 400e, may also feature additional GUI elements at the bottom of the GUI that may or may not be interactable (e.g., a home button GUI element that brings the user to a home GUI upon interacting with it, a non-interactable battery GUI element, etc.).

The user interacting with the interactable input element 406e may input text and/or numeric values. For example, the user interacting with the input text box element featuring the text “Send a message” may cause an interactive keyboard GUI (not shown) to be displayed allowing the user to enter text and/or numeric values into the interactable input element 406e. As another example, the user interacting with one or more external devices (e.g., a mouse and keyboard) may be able to enter text and/or numeric values into the interactable input element 406e. The user interacting with the interactable element 408e may cause the input data (e.g., text and/or numeric values) in the interactable input element 406e to be transmitted to the one or more computing systems described herein (e.g., the generative diagnostic machine learning model, the generative prognostic machine learning model, and/or the generative diagnostic prediction machine learning model).

In operation, the AI diagnostic display device may receive a set of previous conditions of the vehicle, a set of previous symptomatic data, and/or a set of prior repair or maintenance procedures performed on the vehicle (e.g., at the direction of the user via the chat-based AI described above). The set of previous conditions of the vehicle, the set of previous symptomatic data, and/or the set of prior repair or maintenance procedures performed on the vehicle may then be input into the generative diagnostic prediction machine learning model to predict one or more future conditions of the vehicle and/or the predict one or more suggested repair or maintenance procedures to be performed on the vehicle. As illustrated in FIG. 4E, the AI diagnostic display device may then output a result of the generative diagnostic prediction machine learning model (e.g., the future condition of the vehicle and/or the suggested repair or maintenance procedure to be performed on the vehicle) to the user. In this illustrated example, the computing system has determined a pattern of oil changes of the vehicle approximately every 44,500 miles driven and, thus, determines that the vehicle may be due for an oil change in approximately 20 days (e.g., the suggested repair or maintenance procedure to be performed on the vehicle).

The GUIs depicted in FIGS. 4A-4E are not limited to the aforementioned and/or illustrated exemplary embodiments. For example, while the GUIs depicted in FIGS. 4A-4E are formatted for an electronic device in the form of a tablet device, the GUIs depicted in FIGS. 4A-4E may be designed for other devices (e.g., desktop and/or laptop computers, mobile phones, smart devices, etc.). Additionally, the layout and/or the elements of the GUIs depicted in FIGS. 4A-4E may include more or less detail, different language, alternative placement of elements, different ordering, and/or the like. Further, the GUIs depicted in FIGS. 4A-4E described herein are not exhaustive, nor should their inclusion be interpreted as a necessary or unnecessary function of the techniques, methods, and systems disclosed herein.

### ADDITIONAL CONSIDERATIONS

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed is:

1. An artificial intelligence (AI) diagnostic display device for predictive automotive diagnosis comprising:
one or more processors;
one or more memories accessible by the one or more processors;
a generative diagnostic prediction machine learning model deployed on the one or more memories, wherein the generative diagnostic prediction machine learning model is trained on a training set of symptomatic data and a training set of repair or maintenance procedures, and the training set of symptomatic data includes: (i) one or more training symptoms comprising at least one of (A) one or more training generated error codes from a vehicle or (B) one or more training symptomatic descriptions of the vehicle and (ii) training date data of when each training symptom occurred;
an interactive display communicatively coupled to the one or more processors; and
computing instructions stored on the one or more memories that, when executed, cause the one or more processors to:
receive a set of symptomatic data of the vehicle relating to detected conditions of the vehicle, wherein each symptomatic data includes: (i) one or more symptoms comprising at least one of (A) one or more generated error codes from the vehicle or (B) one or more symptomatic descriptions of the vehicle from a user and (ii) date data of when each symptom was detected;
receive a set of repair or maintenance procedures of the vehicle relating to addressing each symptom in the set of symptomatic data;
input the set of symptomatic data and the set of repair or maintenance procedures into the generative diagnostic prediction machine learning model to generate one or more predicted error conditions of the vehicle; and
present, via the interactive display, at least a portion of the one or more predicted error conditions.

2. The AI diagnostic display device of claim 1, wherein:
the generative diagnostic prediction machine learning model generates two or more predicted error conditions,
generating the two or more predicted error conditions causes the one or more processors to:
generate a condition confidence score for each predicted error condition; and
sort the two or more predicted error conditions based upon a greatest value among the generated condition confidence scores, and
presenting the portion of the one or more predicted error conditions causes the one or more processors to:
present, via the interactive display, at least a portion of the sorted two or more predicted error conditions.

3. The AI diagnostic display device of claim 1, wherein the computing instructions, when executed, further cause the one or more processors to:
receive current symptomatic data related to a current condition of the vehicle;
update the set of symptomatic data with the current symptomatic data;
incorporate the updated set of symptomatic data into the training set of symptomatic data; and
retrain the generative diagnostic prediction machine learning model using the updated training set of symptomatic.

4. The AI diagnostic display device of claim 3, wherein the computing instructions, when executed, further cause the one or more processors to:
generate one or more current repair or maintenance procedures of the vehicle to address one or more current symptoms of the current symptomatic data;
present, via the interactive display, at least a portion of the one or more current repair or maintenance procedures;
update the set of repair or maintenance procedures with the one or more current repair or maintenance procedures;
incorporate the updated set of repair or maintenance procedures into the training set of repair or maintenance procedures; and
retrain the generative diagnostic prediction machine learning model using the updated training set of repair or maintenance procedures.

5. The AI diagnostic display device of claim 4, wherein:
two or more current repair or maintenance procedures are generated,
generating the two or more current repair or maintenance procedures causes the one or more processors to:
generate a confidence score for each current repair or maintenance procedure; and
sort the two or more current repair or maintenance procedures based upon a greatest value among the generated confidence scores, and
presenting the portion of the one or more current repair or maintenance procedures causes the one or more processors to:
present, via the interactive display, at least a portion of the sorted two or more current repair or maintenance procedures.

6. The AI diagnostic display device of claim 4, wherein the computing instructions, when executed, further cause the one or more processors to:
receive a list of one or more missing items necessary to perform the one or more current repair or maintenance procedures;
receive a geographical location of the user;
determine one or more product listings of each missing item;
sort the one or more product listings based one or more of: (i) price of each product listing or (ii) total distance between a geographical location of each product listing and the geographical location of the user;
present, via the interactive display, at least a portion of the sorted one or more product listings;
receive one or more user selections of the sorted one or more product listings; and
order the missing items from the sorted one or more product listings based upon the one or more user selections.

7. The AI diagnostic display device of claim 6, wherein the computing instructions, when executed, further cause the one or more processors to:
present, via the interactive display, dynamic instructions on how to perform the one or more current repair or maintenance procedures, wherein the dynamic instructions change based upon one or more user interactions;
receive, via the interactive display, one or more user interactions;
update the dynamic instructions based upon the one or more interactions; and
present, via the interactive display, the updated dynamic instructions.

8. The AI diagnostic display device of claim 7, wherein at least one of: (i) the portion of the one or more predicted error conditions, (ii) the portion of the one or more current repair or maintenance procedures, (iii) the portion of the sorted one or more product listings, (iv) the dynamic instructions, or (v) present are outputted by a chat-based dialogue having access to the generative diagnostic prediction machine learning model, and the AI diagnostic display device receives at least one of: (i) the set of symptomatic data, (ii) the set of repair or maintenance procedures, (iii) the current symptomatic data, (iv) the list of one or more missing items, (v) the geographical location of the user, (vi) the one or more user selections, or (vii) the one or more user interactions via the user interacting with the chat-based dialogue using the interactive display.

9. An artificial intelligence (AI) based method for predictive automotive diagnosis comprising:
receiving, by one or more processors, a set of symptomatic data of a vehicle relating to detected conditions of the vehicle, wherein each symptomatic data includes: (i) one or more symptoms comprising at least one of (A) one or more generated error codes from the vehicle or (B) one or more symptomatic descriptions of the vehicle from a user and (ii) date data of when each symptom was detected;
receiving, by the one or more processors, a set of repair or maintenance procedures of the vehicle relating to addressing each symptom in the set of symptomatic data;
inputting, by the one or more processors, the set of symptomatic data and the set of repair or maintenance procedures into a generative diagnostic prediction machine learning model to generate one or more predicted error conditions of the vehicle, wherein the generative diagnostic prediction machine learning model is trained on a training set of symptomatic data and a training set of repair or maintenance procedures, and the training set of symptomatic data includes: (i) one or more training symptoms comprising at least one of (A) one or more training generated error codes from the vehicle or (B) one or more training symptomatic descriptions of the vehicle and (ii) training date data of when each training symptom occurred; and
presenting, by the one or more processors onto an interactive display, at least a portion of the one or more predicted error conditions.

10. The AI based method of claim 9, wherein:
the generative diagnostic prediction machine learning model generates two or more predicted error conditions,
generating the two or more predicted error conditions causes:
generating, by the one or more processors, a condition confidence score for each predicted error condition; and
sorting, by the one or more processors, the two or more predicted error conditions based upon a greatest value among the generated condition confidence scores, and
presenting the portion of the one or more predicted error conditions causes:
presenting, by the one or more processors onto the interactive display, at least a portion of the sorted two or more predicted error conditions.

11. The AI based method of claim 9, wherein the method further comprises:
receiving, by the one or more processors, current symptomatic data related to a current condition of the vehicle;
updating, by the one or more processors, the set of symptomatic data with the current symptomatic data;
incorporating, by the one or more processors, the updated set of symptomatic data into the training set of symptomatic data; and
retraining, by the one or more processors, the generative diagnostic prediction machine learning model using the updated training set of symptomatic.

12. The AI based method of claim 11, wherein the method further comprises:
generating, by the one or more processors, one or more current repair or maintenance procedures of the vehicle to address one or more current symptoms of the current symptomatic data;
presenting, by the one or more processors onto the interactive display, at least a portion of the one or more current repair or maintenance procedures;
updating, by the one or more processors, the set of repair or maintenance procedures with the one or more current repair or maintenance procedures;
incorporating, by the one or more processors, the updated set of repair or maintenance procedures into the training set of repair or maintenance procedures; and
retraining, by the one or more processors, the generative diagnostic prediction machine learning model using the updated training set of repair or maintenance procedures.

13. The AI based method of claim 12, wherein:
two or more current repair or maintenance procedures are generated,
generating the two or more current repair or maintenance procedures causes:
generating, by the one or more processors, a confidence score for each current repair or maintenance procedure; and
sorting, by the one or more processors, the two or more current repair or maintenance procedures based upon a greatest value among the generated confidence scores, and
presenting the portion of the one or more current repair or maintenance procedures causes:
presenting, by the one or more processors onto the interactive display, at least a portion of the sorted two or more current repair or maintenance procedures.

14. The AI based method of claim 12, wherein the method further comprises:
receiving, by the one or more processors, a list of one or more missing items necessary to perform the one or more current repair or maintenance procedures;
receiving, by the one or more processors, a geographical location of the user;
determining, by the one or more processors, one or more product listings of each missing item;
sorting, by the one or more processors, the one or more product listings based one or more of: (i) price of each product listing or (ii) total distance between a geographical location of each product listing and the geographical location of the user;
presenting, by the one or more processors onto the interactive display, at least a portion of the sorted one or more product listings;
receiving, by the one or more processors, one or more user selections of the sorted one or more product listings; and
ordering, by the one or more processors, the missing items from the sorted one or more product listings based upon the one or more user selections.

15. The AI based method of claim 14, wherein the method further comprises:
presenting, by the one or more processors onto the interactive display, dynamic instructions on how to perform the one or more current repair or maintenance procedures, wherein the dynamic instructions change based upon one or more user interactions;
receiving, via the interactive display, one or more user interactions;
update the dynamic instructions based upon the one or more interactions; and
presenting, via the interactive display, the updated dynamic instructions.

16. The AI based method of claim 15, wherein at least one of: (i) the portion of the one or more predicted error conditions, (ii) the portion of the one or more current repair or maintenance procedures, (iii) the portion of the sorted one or more product listings, (iv) the dynamic instructions, or (v) present are outputted by a chat-based dialogue having access to the generative diagnostic prediction machine learning model, and the one or more processors receives at least one of: (i) the set of symptomatic data, (ii) the set of repair or maintenance procedures, (iii) the current symptomatic data, (iv) the list of one or more missing items, (v) the geographical location of the user, (vi) the one or more user selections, or (vii) the one or more user interactions via the user interacting with the chat-based dialogue using the interactive display.

17. A tangible, non-transitory computer-readable medium storing instructions for tracking reusable containers that when executed by one or more processors cause the one or more processors to:
receive a set of symptomatic data of a vehicle relating to detected conditions of the vehicle, wherein each symptomatic data includes: (i) one or more symptoms comprising at least one of (A) one or more generated error codes from the vehicle or (B) one or more symptomatic descriptions of the vehicle from a user and (ii) date data of when each symptom was detected;
receive a set of repair or maintenance procedures of the vehicle relating to addressing each symptom in the set of symptomatic data;
input the set of symptomatic data and the set of repair or maintenance procedures into a generative diagnostic prediction machine learning model to generate one or more predicted error conditions of the vehicle, wherein the generative diagnostic prediction machine learning model is trained on a training set of symptomatic data and a training set of repair or maintenance procedures, and the set of predictive symptomatic data includes: (i) one or more predicted symptoms comprising at least one of (A) one or more predicted generated error codes from the vehicle or (B) one or more predicted symptomatic descriptions of the vehicle and (ii) predicted date data of when each predicted symptom occurred; and
present, via an interactive display, at least a portion of the one or more predicted error conditions.

18. The tangible, non-transitory computer-readable medium of claim 17, wherein the instructions, when executed, further cause the one or more processors to:
receive current symptomatic data related to a current condition of the vehicle;
update the set of symptomatic data with the current symptomatic data;
incorporate the updated set of symptomatic data into the training set of symptomatic data;
retrain the generative diagnostic prediction machine learning model using the updated training set of symptomatic;
generate one or more current repair or maintenance procedures of the vehicle to address one or more current symptoms of the current symptomatic data;
present, via the interactive display, at least a portion of the one or more current repair or maintenance procedures;
update the set of repair or maintenance procedures with the one or more current repair or maintenance procedures;
incorporate the updated set of repair or maintenance procedures into the training set of repair or maintenance procedures; and
retrain the generative diagnostic prediction machine learning model using the updated training set of repair or maintenance procedures.

19. The tangible, non-transitory computer-readable medium of claim 18, wherein the computing instructions, when executed, further cause the one or more processors to:
receive a list of one or more missing items necessary to perform the one or more current repair or maintenance procedures;
receive a geographical location of the user;
determine one or more product listings of each missing item;
sort the one or more product listings based one or more of: (i) price of each product listing or (ii) total distance between a geographical location of each product listing and the geographical location of the user;
present, via the interactive display, at least a portion of the sorted one or more product listings;
receive one or more user selections of the sorted one or more product listings;
order the missing items from the sorted one or more product listings based upon the one or more user selections;
present, via the interactive display, dynamic instructions on how to perform the one or more current repair or maintenance procedures, wherein the dynamic instructions change based upon one or more user interactions;
receive, via the interactive display, one or more user interactions;
update the dynamic instructions based upon the one or more interactions; and
present, via the interactive display, the updated dynamic instructions.

20. The tangible, non-transitory computer-readable medium of claim 19, wherein at least one of: (i) the portion of the one or more predicted error conditions, (ii) the portion of the one or more current repair or maintenance procedures, (iii) the portion of the sorted one or more product listings, (iv) the dynamic instructions, or (v) present are outputted by a chat-based dialogue having access to the generative diagnostic prediction machine learning model, and the one or more processors receive at least one of: (i) the set of symptomatic data, (ii) the set of repair or maintenance procedures, (iii) the current symptomatic data, (iv) the list of one or more missing items, (v) the geographical location of the user, (vi) the one or more user selections, or (vii) the one or more user interactions via the user interacting with the chat-based dialogue using the interactive display.
